(19) United States
(12) Patent Application Publication
(10) Pub. No.: US 2011/0303616 A1
(43) Pub. Date: Dec. 15, 2011

(54) OIL RECOVERY SYSTEM AND METHOD

(76) Inventors: Robert G. Cox, Mobile, AL (US); William J. Cox, Pensacola, FL (US)

(21) Appl. No.: 13/158,071

(22) Filed: Jun. 10, 2011

Related U.S. Application Data
(60) Provisional application No. 61/353,343, filed on Jun. 10, 2010.

(51) Int. Cl. E02B 15/10; C02F 1/00; C02F 101/32

(52) U.S. Cl. 210/747.6; 210/170.05

(57) ABSTRACT

A system for recovering floating oil from the surface of a body of water includes a sump vertically movably mounted between a pair of spaced interconnected floating pontoons. A hydraulic system is coupled to the sump for lowering the sump into the water below the pontoons to a predetermined depth. The forward wall of the sump is angled down and back from an upper edge and a blade is hingedly attached along the upper edge of the forward wall. In use, the sump is lowered into the water until the blade is at the proper slice depth to separate floating oil from the surface of the water as the pontoons are drawn through an oil spill in a forward direction. The separated oil is deposited immediately onto the angled forward wall where gravity causes it to accelerate downwardly along the angled wall. This “gravity drop” tends to pull or urge additional oil across the blade and onto the angled forward wall to enhance the separation of floating oil from the surface of the water. A wave plate extends above and forward of the blade to maintain the slice depth as the system encounters waves and to prevent waves from crashing into the sump.

### RELATED APPLICATIONS

Priority is hereby claimed to the filing date of U.S. provisional patent application No. 61/353,343 filed on 10 Jun. 2010.

### TECHNICAL FIELD

This disclosure relates generally to environmental remediation and more specifically to removal of oil and other floating environmental hazards from the surface of a body of water.

### BACKGROUND

An oil spill from an off-shore oil rig or tanker can be an environmental disaster of monumental proportions. Witness, for example, the Exxon Valdez oil spill in Prince William Sound, Ak. in March, 1989 and more recently the Deep Water Horizon disaster off the coast of Louisiana in the Gulf of Mexico. When such tragedies occur, floating oil, dispersants, and other related hazardous material must be removed from the surface of the water. This historically is done in a variety of ways, including the use of oil skimmers, which can take a variety of forms. For example, there are rotating drum skimmers, moving ribbon skimmers, boom skimmers, and the like. Present skimmers, however, have their own inherent problems and shortcomings. Other oil removal techniques involve corralling floating oil with a boom and recovering or burning it at sea, absorbing it with floating booms, and many others, all of which can be inefficient and ineffective. A need therefore exists for a system and method of collecting floating oil and other environmental hazards from the surface of a body of water that is simple, reliable, continuously operating, effective, and efficient. It is to the provision of such a system and method that the present invention is primarily directed.

### SUMMARY

Briefly described, a system for removing floating oil and other environmental hazards from the surface of a body of water such as an ocean, gulf, or bay comprises a floating platform having a port pontoon and a starboard pontoon defining a space between them. A sump is disposed between the pontoons near the forward end of the floating platform and has substantially vertical rear and side walls, a floor, and a front wall that is angled upwardly and forwardly from the floor to a forward edge. The sump is suspended and can be raised and lowered as needed. A deck and/or connecting structure spans the port and starboard pontoons to tie the pontoons together and support hosing, hydraulic pumps, and other ancillary equipment used in the operation of the system.

A blade is hingedly attached to and along the upper forward edge of the sump and a wave plate is attached to the sump and extends upwardly and forwardly above the hingedly attached blade. The blade can be hinged downwardly toward and beyond a substantially horizontal attitude to widen the gap between the blade and the wave plate and can be hinged upwardly toward a substantially vertically oriented attitude to narrow the gap between the blade and the wave plate. The blade can be oriented at any angle between its extremes to adjust to factors such as rough or smooth seas and thick or thin oil slicks. Varying the angle of the blade varies the depth at which the forward edge of the blade moves through the water. This depth is referred to as the “slice depth” and can be different for different conditions such as thick and thin oil slicks.

A wave plate extends upwardly and forwardly above the blade. The wave plate functions to help maintain the slice depth continuously, particularly in rougher seas. More specifically, larger waves impact the bottom of the wave plate and the force of the wave on the wave plate urges the sump upwardly so that the blade substantially follows the contour of the wave and maintains its slice depth as the wave passes. A hydraulic pump is disposed in the bottom of the sump and is configured to pump or push collected oil and other material from the sump to a storage vessel through appropriate hoses. The storage vessel may be the vessel that tows the platform of this invention, or a separate storage vessel, or any vessel associated with an oil collection operation that is capable of storing in its hold the materials collected by the system of this invention.

In use, the system is deployed within an oil slick and, in one method of operation, tethered to a tow vessel (or other appropriate vessel) for towing the platform through the oil slick. A storage vessel, which may or may not be the tow vessel itself, is made available for receiving collected oil and other materials from the platform. The tow vessel tows the platform to one side through the slick. The sump is lowered into the water until the blade is approximately at surface level and the attitude of the blade is adjusted to the appropriate slice depth so that floating oil is substantially separated or “sliced” from the surface of the water by the blade. The substantially separated oil moves over the blade and onto the downwardly sloped forward wall of the sump. In rougher seas, the wave plate helps to maintain the blade at its appropriate slice depth and to prevent waves from crashing into the sump. Gravity begins to accelerate the oil down the forward wall toward the bottom of the sump. It has been discovered that this downwardly accelerating motion of the oil, referred to as a gravity drop, tends to pull additional oil over the blade and down into the sump by virtue of the viscosity and surface properties of the oil. This, in turn, enhances the separation of oil from the water by the blade. The depth to which the sump is submerged and the angle of the blade can be adjusted as needed to accommodate for rough or smooth seas, thick or thin oil, or other factors until the efficiency of the separation and collection is maximized. Water that invariably is collected with the oil can be decanted with a pump from the hold of the storage vessel or the sump itself and expelled back in front of the platform so that any residual residue in the decanted water can be recycled back through the system and not jettisoned into open water.

Thus, an oil removal system and method is now provided that is efficient, effective, able to operate continuously without down time and that is continuously adjustable to accommodate changing sea and oil conditions. These and other features, aspects, and advantages of the system and method disclosed and claimed herein will become more apparent upon review of the detailed description set forth below when taken in conjunction with the accompanying drawing figures, which are briefly described as follows.

### BRIEF DESCRIPTION OF THE DRAWINGS

FIG. 1 is a side view of a platform that embodies principles of the present invention in one preferred form.

FIG. 2 is a perspective view of the forward portion of the platform showing the sump, the rudder, and hydraulic lift system for lowering and raising the sump.

FIG. 3 is and enlarged perspective view showing the forward wall of the sump, the hinged blade at the top of the forward wall, and the wave plate.

FIG. 4 is an enlarged perspective of a portion of the blade and a portion of the wave plate showing the blade hinged downwardly forming a relatively large gap between the blade and wave plate.

FIG. 5 is an enlarged perspective of a portion of the blade and a portion of the wave plate showing the blade hinged upwardly forming a relatively small gap between the blade and the wave plate.

FIG. 6 is a perspective from the aft deck of the platform looking forward across the sump and showing the gantries and hydraulic cylinders for lowering and raising the sump.

FIG. 7 is a view into the sump showing the aft wall of the sump and support rollers behind the sump.

FIG. 8 is a simplified cross sectional diagram illustrating separation and collection of floating oil from the surface of a body of water according to one embodiment of the invention.

FIG. 9 illustrates the operation of the wave plate in rougher seas to adjust automatically the slice depth to follow substantially the contours of larger waves encountered by the system.

### DETAILED DESCRIPTION

U.S. provisional patent application No. 61/353,343, to which priority is claimed above, is hereby incorporated by reference in its entirety.

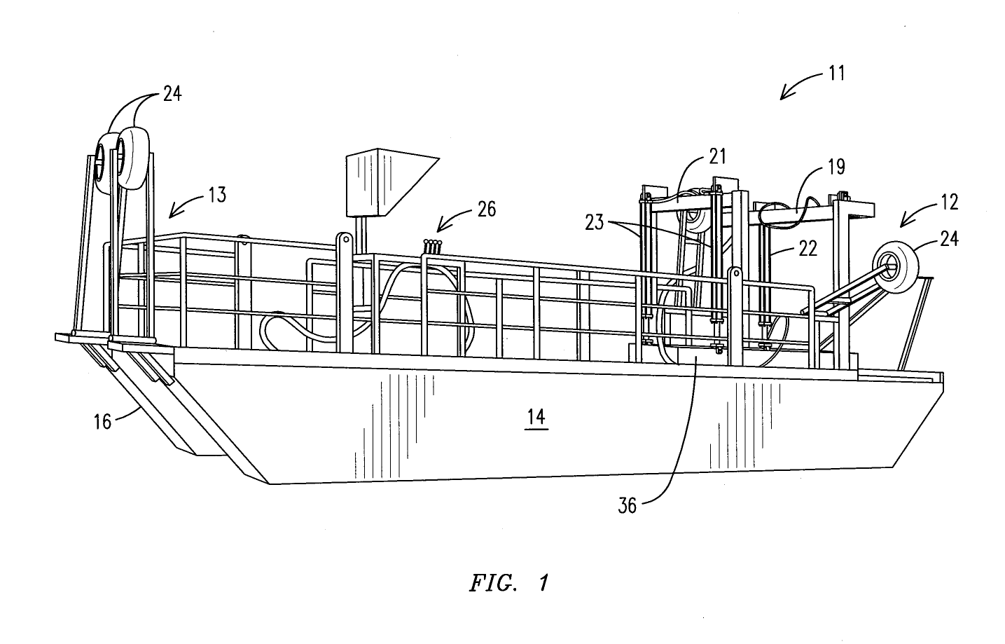

Reference will now be made in more detail to the accompanying drawing figures, wherein like reference numerals indicate like parts throughout the several views. FIG. 1 illustrates one embodiment of a system for removing oil from the surface of a body of water according to principles of the invention. The system includes a floating platform 11 having a bow section 12, a stern section 13, a starboard pontoon 14, and a port pontoon 15. The pontoons 14 and 15 are spaced apart from each other to define a space or well between them. The forward portion of the well is open to water below while a connecting structure that may include a deck (not visible in the figures) spans the well and secures the pontoons together. The connecting structure and/or deck may support various operational elements such as hoses, hydraulic pumps, hydraulic controls 26, and other items. Deployable roller bumpers 24 can be hinged downwardly in situations where the system is operated closely beside a tow vessel or other associated vessel. The deployed roller bumpers engage and ride on the tow vessel so that the platform 11 can ride any wave action more freely, which prevents the tow vessel from hindering the system's ability to track closely along the surface of the water during operation.

A forward support frame 19 and an aft support frame 21 are connected to the pontoons and extend up and over the bow portion of the platform as shown. The forward support frame 21 supports vertically oriented forward hydraulic cylinders 22 and the aft support frame 21 supports vertically oriented aft hydraulic cylinders 23. The hydraulic cylinders 22 and 23 are coupled at their lower ends to a sump 36 (detailed below) and selective activation of the hydraulic cylinders causes the sump 36 to be lowered within the well between the pontoons into water below and submerged to a desired depth, or raised to a stowed position as illustrated in FIG. 1, or positioned anywhere in between. While hydraulic cylinders are preferred, it will be understood that any other technique for raising and lowering the sump can be substituted including cables and pulleys, racks and pinions, or any other structures. Thus “hydraulic cylinders” used herein should be construed to cover any mechanisms that facilitate the raising and lowering of the sump.

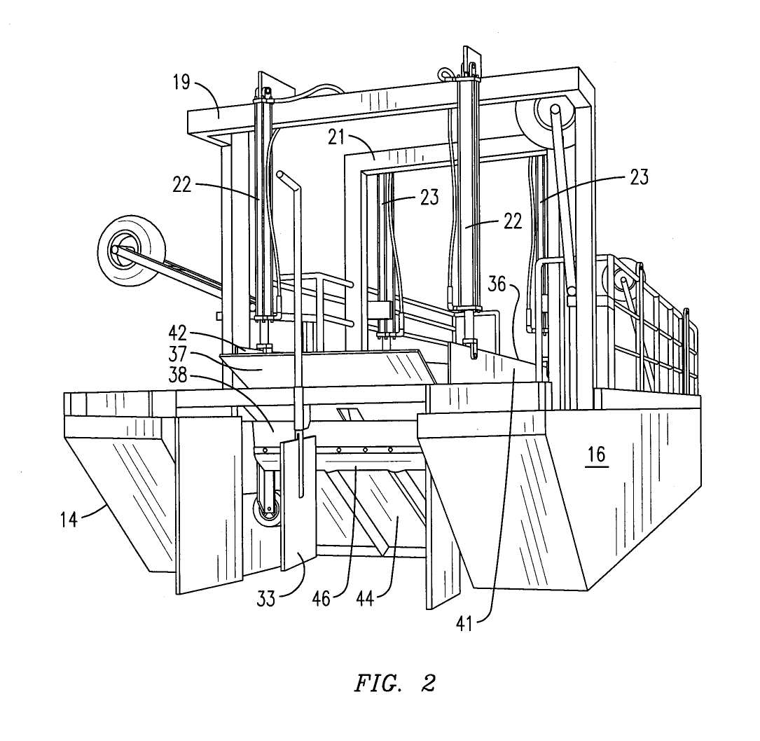

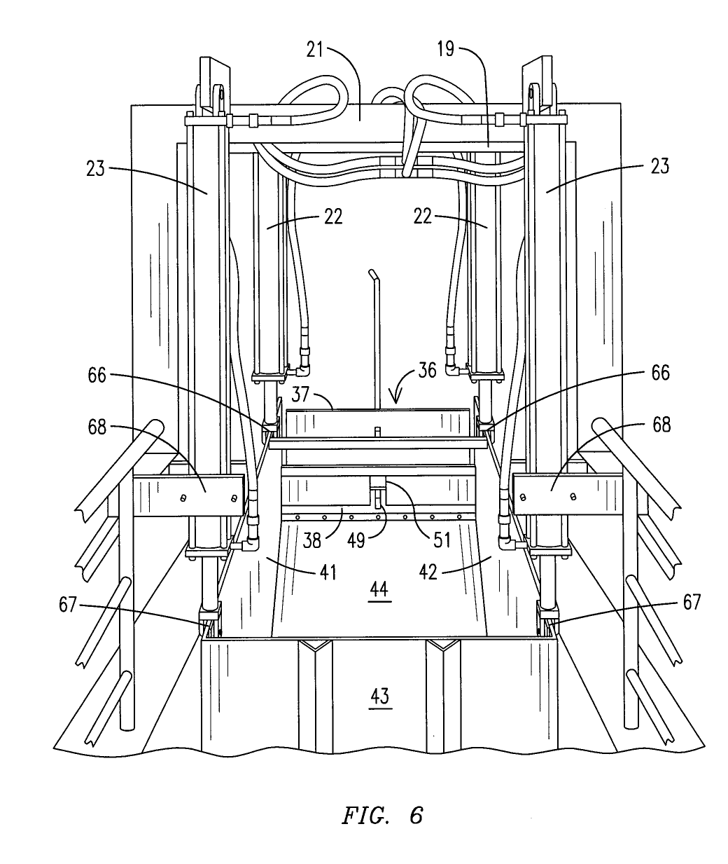

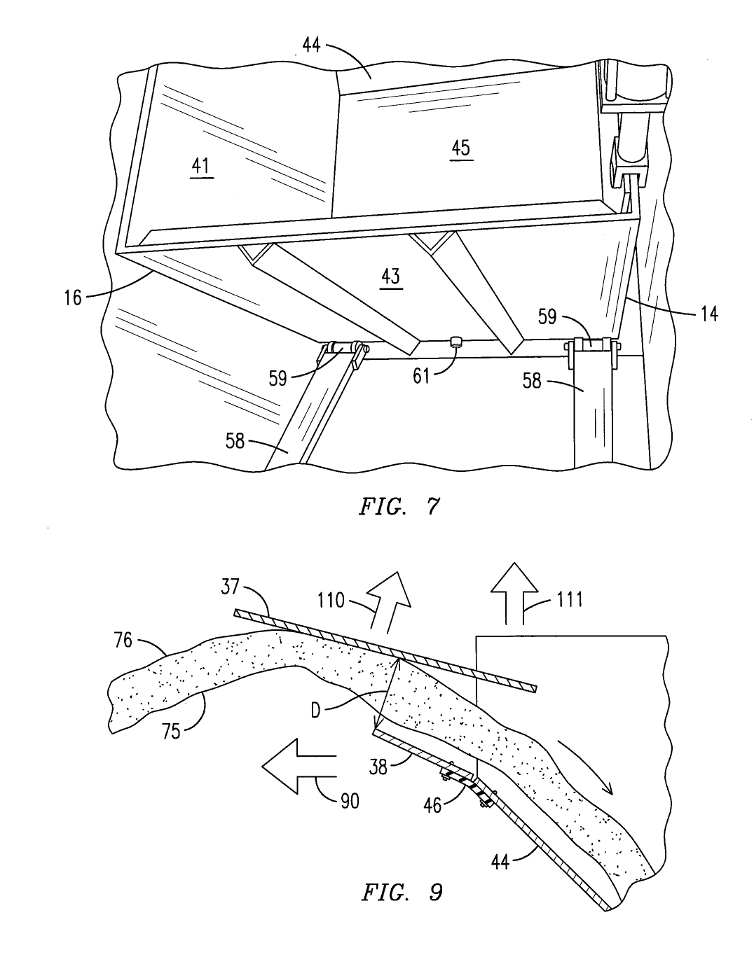

FIG. 2 is a view of the platform 11 looking toward the bow section thereof. The port and starboard pontoons 16 and 14 respectively are seen to define between them the well within which is disposed the sump 36. As perhaps better illustrated in FIG. 6, the sump 36 has a port side wall 41, a starboard side wall 42, an aft wall 43, a forward wall 44, and a floor 45 (FIG. 7). The side and aft walls of the sump are substantially vertically oriented; however, the forward wall 44 extends upwardly from the floor 45 at a predetermined angle to an upper edge. The angle can be between about 10 degrees and about 70 degrees but most preferably is about 45 degrees relative to horizontal. An elongated blade 38 is hingedly attached along the upper edge of the forward wall and can be hinged or pivoted up or down as described in more detail below. A wave plate 37 is affixed to the sump and extends generally upwardly and forwardly over the blade 38 to maintain the slice depth of the blade when larger waves are encountered and to prevent these waves from crashing over the blade and into the sump. Significantly, the rudder 33 is located forwardly of the midpoint of the platform 11 between the pontoons. This enhances steering of the platform through an oil slick.

The side walls of the sump 36 are connected to the piston rods of forward double acting hydraulic cylinders 22 and aft double acting hydraulic cylinders 23. Activating the cylinders to extend their piston rods therefore lowers the sump relative to the platform and relative to the surface of the water while activating the cylinders to retract their piston rods raises the sump relative to the platform and the surface of the water. Of course, the cylinders can be connected and activated in a number of ways with similar results.

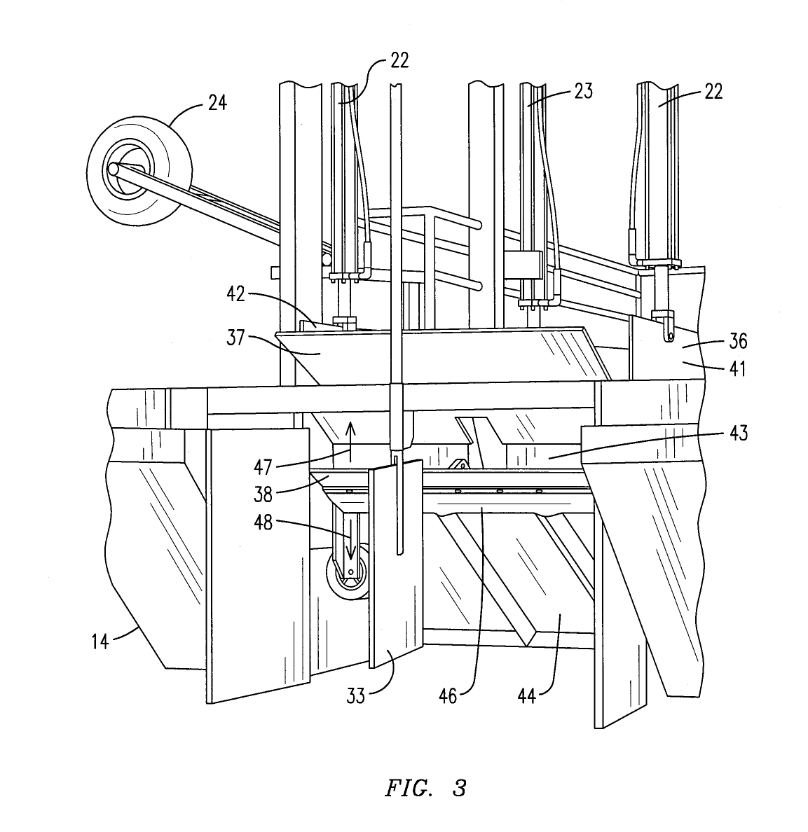

FIG. 3 illustrates perhaps better the configuration of the sump 36 and its various related components. As mentioned, the forward wall 44 is seen to be angled upward and forwardly from the floor of the sump to an upper edge. The blade 38 is a relatively thin elongated piece of metal and is hingedly attached to the upper edge of the forward wall 44. In the illustrated embodiment, the blade 38 is attached by means of a flexible hinge 46 so that it is smoothly adjustable in angle. It will thus be seen that the blade is capable of being hinged upwardly toward the wave plate 37 as illustrated by arrow 47 or downwardly away from the wave plate 37 as indicated by arrow 48. When hinged upwardly, a relatively narrow gap is formed between the edge of the blade and the wave plate and when hinged downwardly, a relatively large gap is formed between the edge of the blade and the wave plate. The blade can be angled downwardly beyond a horizontal attitude if desired and this has been found advantageous for collecting oil from certain types of oil slicks. The gap is set to correspond to specific conditions such as the thickness and consistency of the floating oil, sea conditions, and the like. As detailed below relative to FIG. 9, the wave plate in conjunction with the selected gap helps maintain the blade at the proper slice depth as the platform encounters larger waves and also prevents waves from breaking or crashing into the sump.

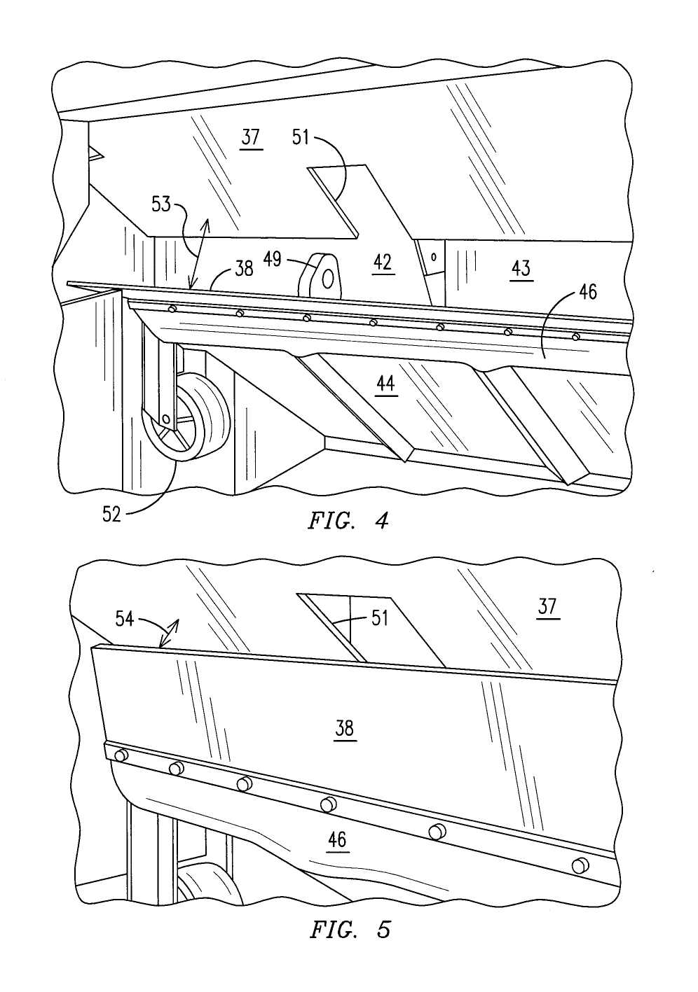

FIG. 4 is an even more enlarged view of the blade 38 and wave plate 37. The blade 38 is seen in this view to be hinged downwardly so that a relatively large gap 53 is formed between the blade and the wave plate 37. Such an attitude of the blade might be appropriate, for example, where an oil slick consists of thick viscous oil that is most efficiently collected with a deeper slice depth. An attachment lug 49 is affixed to the blade 38 to allow the blade to be attached to a controlling cylinder or other mechanism to set the attitude of the blade to a desired angle. A gap 51 is formed in the wave plate to accommodate the controlling cylinder. As discussed, the attitude of the blade 38 can be adjusted as necessary to accommodate for rough or calm seas, for thick or thin oil slicks, or any other conditions in order to maximize the efficiency of separation and collection of surface born oil. One roller 52 of a set of rollers is shown affixed to the sump. The rollers bear against the sides of the pontoons to steady the sump as it moves upwardly and downwardly through the well between the pontoons. Also visible in FIG. 4 is the aft wall 43 and the starboard wall 42 of the sump.

In FIG. 5, the blade 38 is shown hinged to an upwardly angled or raised attitude such that a relatively narrow gap 54 is defined between the edge of the blade and the wave plate 37. Such an attitude might correspond, for example, to a disbursed thin oil slick that is most efficiently removed using a shallow slice depth. It has also been found that angling the blade downwardly beyond a horizontal attitude also may be effective when collecting oil from a thin oil slick. The blade can be positioned anywhere between its two extremes to maximize the efficiency of separation and collection of oil in virtually any sea and oil slick conditions.

FIG. 6 illustrates perhaps better the components of the sump 36 and the rigging that facilitates the raising and lowering of the sump. As mentioned, the sump 36 has substantially vertical port and starboard side walls 41 and 42 and a substantially vertical aft wall 43. The forward wall 44 of the sump is angled upwardly as shown to an upper edge along which the blade 38 is hingedly attached. The wave plate 37, with its gap 51, is also visible in FIG. 6. Forward hydraulic cylinders 22 are attached at their upper ends to the forward support frame 19 and depend therefrom. The piston rods of the forward hydraulic cylinders 22 are attached to the port and starboard walls of the sump at 66. The forward cylinders are free to pivot about their attachment points to the support frame and their attachment points 66 to the sump walls to accommodate adjustment of the attitude of the sump when it is lowered into the water. Aft hydraulic cylinders 23 are attached at their upper ends to the aft support frame 21 and their piston rods are attached to the aft ends of the side walls of the sump at 67. The aft hydraulic cylinders 23 are fixed in their vertical orientations by brackets 68, but attachment points 67 are pivotable to accommodate adjustments of the attitude of the sump.

The sump 36 is seen to be disposed in the well between the port and starboard pontoons. Accordingly, extending the hydraulic cylinders lowers the sump within the well and into water below while retracting the hydraulic cylinders raises the sump toward its stowed position shown in FIG. 6. Further, the attitude of the sump can be adjusted if desired by extending the forward hydraulic cylinders more than the aft cylinders to tilt the forward end of the sump down, or less than the aft cylinders to tilt the forward end of the sump up relative to the aft end of the sump. This provides for adjustability of the angle of the forward wall of the sump in the water. The forward and aft hydraulic cylinders are operated by a traditional hydraulic pump and control system (not shown), the controls of which are indicated at 26 in FIG. 1.

FIG. 7 is a view into the sump and shows a portion of the floor 45 of the sump, the port side wall 41, and the angled forward wall 44. The sump is supported from behind during raising and lowering and in operation by support brackets 58, which terminate in rollers 59 against which the aft wall 43 of the sump rides. An outlet port 61 communicates with the interior of the sump. In operation, a hose from a pump within the sump is connected through the outlet port 61 and through external hoses to a storage vessel for removing collected oil and other environmental hazards as well as any collected water from the sump and push-pumping it to the storage vessel. Pushing the collected material through hoses rather than pulling it with a pump on the storage vessel is preferred because the material can be pushed much farther than pulled. The pump within the sump preferably is a hydraulic pump with high pressure hydraulic fluid being supplied from hydraulic equipment on the storage vessel or elsewhere. The collected material preferably is continuously pumped to a tow vessel or other storage vessel to be stored so that the oil recovery system can operate continuously until the storage vessel is filled.

As oil and other contaminates are sliced by the blade, separated from the surface, and move into the sump, some water also is collected and moves into the sump with the oil. Accordingly, the collected water is also pumped with the oil to the storage vessel. It is desirable to remove this collected water from the collected oil in order to maximize the volume of oil and contaminates that can be stowed in the storage vessel. This can be done on the storage vessel by any appropriate technique such as, for example, a decanting operation wherein the collected water is pumped from the bottom of the storage vessel's hold. However, the decanted water is still partially contaminated with oil and other collected hazards and cannot simply be jettisoned into open water. To address this problem, the inventors have discovered somewhat surprisingly that the decanted water can be piped back to the platform of this invention and expelled in front of the sump and blade assembly. In this way, the partially contaminated decanted water is recaptured and recycled through the system and not released back into open water. It has been found that such recycling of the decanted water is effective and consistent with environmental standards related to release of materials into water.

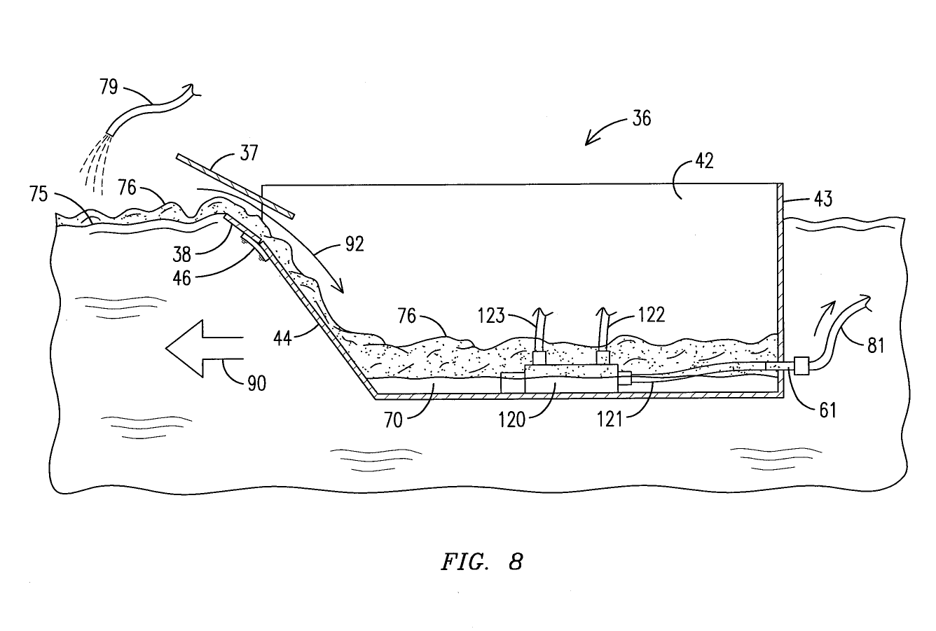

FIG. 8 is a cross-sectional diagram of the sump of this invention in operation and is greatly simplified for ease of illustration and understanding. During operation, the platform carrying the sump 36 is towed or otherwise moved through an oil slick in the direction of arrow 90. Alternatively, the platform may be deployed in a stationary position in a location where the current moves the oil slick relative the stationary platform. The platform and sump may be towed far enough to the side of a tow vessel so that it moves through substantially undisturbed portions of an oil spill. Alternatively, it may be positioned in a wake of the tow or storage vessel if desired to concentrate the floating oil before it encounters the sump. If positioned next to a larger vessel, the roller bumpers 24 (FIG. 1) may be deployed so that the larger vessel does not hinder the system's ability to track the surface of the water. Further, a concentration guide boom can be deployed from the forward end of the sump if desired to concentrate the oil and create a wider swath of coverage. In any event, the sump is lowered into the water and the attitude of the blade is adjusted so that the blade 38 is positioned to “slice” floating oil 76 and other contaminates and thereby to separate them substantially from the surface 75 of the water. The angle of the blade is adjusted so that the gap between the blade 38 and the wave plate 37 is approximately equal to the desired slice depth for purposes described below relative to FIG. 9. In some situations, the blade may be hinged to a downwardly oriented attitude. This has been found useful in collecting oil from some types of oil slicks.

As the platform is towed or otherwise moved in a forward direction through the oil spill, the blade rides at its slice depth just beneath the floating oil 76. The forward movement of the platform relative to the oil causes the blade to slice and substantially separate the floating oil from the water and deposit the separated oil onto the angled forward wall of the sump as indicated at 92. Gravity tends to accelerate the oil down the surface of the forward wall in a gravity drop. Surprisingly, it has been found that this gravity drop of the oil into the sump advantageously tends to pull additional oil over the blade and onto the angled forward wall. Without wishing to be bound by theory, it is believed that this is due to the viscosity and surface properties of the oil. In any event, once oil collection begins, the process is somewhat self-sustaining as separated oil accelerating down the forward wall under the influence of gravity helps to draw more oil across the blade and into the sump behind it. As the platform 11 encounters swells, it tends to ride them up and down, which helps to maintain the blade and sump properly positioned at the surface of the water. Furthermore, when the sump encounters a larger wave, the wave impacts the bottom surface of the wave plate, which tends to raise the sump so that the blade remains substantially at its slice depth while traversing the wave. The hydraulic cylinders also can be used to adjust the position of the sump and thus the blade either independently, continuously, or periodically to conform to changing surface conditions.

An oil evacuation hose 81 is coupled to the outlet port 61 and extends to a remote storage vessel. A pump 120, which preferably is a hydraulic pump powered through hydraulic hoses 123 and 122, is disposed in the bottom of the sump. Hydraulic fluid preferably is supplied from hydraulic equipment aboard the storage vessel or another associated vessel. The pump is coupled through hose 121 and outlet port 61 to the hose 81. Thus, the pump 120 continuously pumps collected oil and other materials out of the sump and into a storage vessel. The sump is therefore continuously evacuated of collected oil and can be operated continuously until the hold of the storage vessel is filled. The applicants have discovered that recovering floating oil and other environmental hazards with the system as described above is highly efficient and effective and permits collection of large quantities of floating oil in relatively short times.

FIG. 9 illustrates the function of the wave plate 37 to help maintain the slice depth of the blade 38 when a larger wave is encountered. The oil 76 is floating on the surface 75 of the water and the attitude of the blade 38 is adjusted to establish a slice depth D appropriate for the condition of the oil and other conditions. As a larger wave is encountered, the wave impacts the bottom surface of the wave plate 37 as illustrated. This, in turn, imparts a significant upwardly directed force to the wave plate as indicated at 110 in FIG. 9. Since the wave plate is attached to the sump, the upward force 110 causes the sump and the blade 38 to rise upwardly with the wave as indicated at 111. This, in turn, helps to maintain the forward edge of the blade at the appropriate slice depth D as the wave is traversed. In addition, the wave plate 37 prevents waves from breaking violently over the blade and into the sump and thereby reduces the amount of excess water collected in the sump.

During operation, some water is inevitably also collected in the sump along with the oil. This water, which is partially contaminated itself, is pumped along with the oil to the storage vessel. The presence of the water in the storage vessel is undesirable because it occupies a volume of the storage vessel that otherwise could be filled with collected oil. However, the water cannot simply be jettisoned into open water due to environmental and other standards. The inventors have discovered a unique and rather surprising solution to this dilemma. Specifically, it has been discovered that the collected water can be removed or decanted from the hold of the storage vessel, where it tends to collect beneath collected oil. This can be done in a variety of ways such as with an evacuation pump communicating with the bottom portion of the storage hold or otherwise communicating with the collected water in the hold. The decanted and partially contaminated water can then be pumped back to the platform 11 of the present invention and expelled ahead of the sump as indicated at 79 in FIG. 8. The partially contaminated water is thus recaptured and recycled through the system of this invention and is not released into open waters. While decanting preferably occurs at the storage vessel as described, it also may be possible that it occurs within the sump itself so that the decanting and recycling operation is self-contained in the system of the present invention.

The invention has been described herein in terms of preferred and exemplary embodiments that are considered by the inventors to constitute best modes of carrying out the invention. It will be clear to skilled artisans, however, that many variations of the illustrated embodiments are possible within the scope of the invention. For example, while a very simple water and oil evacuation system is illustrated in FIG. 8, much more elaborate systems are possible that may include, for instance, sensors for determining the location of the surface in the sump and a control system for drawing water and oil from the sump at optimum locations. The sump can be made larger or smaller. Further, a plurality of platforms according to this invention can be lashed or otherwise combined together to remove a wider swath of oil from an oil spill. The particular configurations of the pontoons, support frames, sump, and other components of the system are not limiting and virtually any structures that perform the functions of these components regardless of their configurations are included within this disclosure. These and other additions, deletions, and modifications may well be conceived and made by those of skill in the art without departing from the spirit and scope of the invention as set forth in the claims.

What is claimed is:

1. A system for collecting floating hazardous material from the surface of a body of water comprising:
a floating platform configured to be deployed in a field of floating hazardous material so as to establish relative movement between the hazardous material and the platform, the platform having a bow portion, a stern portion, a starboard side, and a port side;
the platform carrying a sump having a forward end and an aft end;
a blade disposed at the forward end of the sump;
a gravity drop surface positioned aft of the blade;
a mechanism on the platform for lowering the sump from the platform into water below until the blade of the sump is positioned to separate floating hazardous material from the surface of the water as the hazardous material and the platform move relative to one another;
the gravity drop surface being configured and oriented to accelerate separated hazardous material into the sump; and
an evacuation system for evacuating collected hazardous material from the interior of the sump.

2. The system of claim 1 and wherein the floating platform comprises a pair of spaced apart pontoons.

3. The system of claim 2 and wherein the sump is located between the pair of spaced apart pontoons.

4. The system of claim 1 and wherein the blade is pivotally attached to the forward end of the sump for selective adjustment of the attitude of the blade relative to horizontal.

5. The system of claim 4 and further comprising a wave plate on the sump located above the blade, adjustment of the attitude of the blade widening or narrowing a gap between the blade and the wave plate to accommodate varying environmental conditions.

6. The system of claim 1 and wherein the gravity drop surface is angled downwardly from the blade toward the aft end of the sump.

7. The system of claim 6 and wherein the gravity drop surface is disposed at an angle between about 10 degrees and about 70 degrees with respect to horizontal.

8. The system of claim 7 and wherein the gravity drop surface is disposed at an angle of about 45 degrees with respect to horizontal.

9. The system of claim 8 and wherein the gravity drop surface comprises a forward wall of the sump and wherein the blade is hingedly attached along an upper edge of the forward wall.

10. The system of claim 1 and wherein the mechanism for lowering the sump comprises extendable cylinders connected to the sump and to the platform.

11. The system of claim 10 and wherein the cylinders are hydraulic cylinders.

12. The system of claim 11 and wherein the hydraulic cylinders comprise a pair of forward cylinders connected to the forward end portion of the sump and a pair of aft cylinders connected to the aft end portion of the sump.

13. The system of claim 12 and further comprising a hydraulic control system configured to operate the pair of forward cylinders independently from the pair of aft cylinders so that the attitude of the sump can be adjusted.

14. A method of collecting floating oil from the surface of a body of water, the method comprising the steps of:
(a) moving a blade and the floating oil relative to each other with the blade being oriented and positioned to separate the floating oil substantially from the surface of the water as the blade and floating oil move relative to each other;
(b) allowing the substantially separated oil to fall through a gravity drop directly behind the blade so that the falling oil tends to pull additional oil across the blade and onto the gravity drop;
(c) collecting the separated oil in a sump; and
(d) removing the collected oil to a storage location as the blade and the floating oil move relative to each other.

15. The method of claim 14 and where in step (a) the blade is attached to a forward end of the sump and wherein the step of moving the blade and the floating oil relative to each other comprises substantially submerging the sump and establishing relative movement between the sump and the floating oil.

16. The method of claim 15 and wherein step (b) comprises allowing the separated oil to move down a forward surface of the sump.

17. The method of claim 16 and wherein step (b) further comprises allowing the separated oil to accelerate under the influence of gravity down an angled forward surface of the sump.

18. The method of claim 14 and further comprising removing from the collected oil at least a portion of any water collected along with the collected oil.

19. The method of claim 18 and further comprising expelling the removed water in the in front of the blade.

20. An apparatus for removing floating oil from the surface of a body of water when the apparatus is moved through an oil spill in a forward direction, the apparatus comprising:
a pair of interconnected spaced apart floating pontoons having bows facing the forward direction and sterns, the floating pontoons defining a well between them;
a sump positioned in the well between the pontoons and having a port wall, a starboard wall, an aft wall, a floor, and a forward wall having an upper edge, the forward wall being angled from its upper edge downwardly and toward the aft wall;
a blade mounted along the upper edge of the forward wall;
a lift mechanism connected to the sump and configured to lower the sump into water below the pontoons and raise the sump to a storage location within the well between the pontoons;
the blade being configured when positioned approximately at water level with the apparatus moving in the forward direction to separate floating oil substantially from the surface of the water and direct the separated oil onto the angled forward wall of the sump;
whereby gravity accelerates the separated oil down the angled forward wall tending to pull additional oil across the blade and onto the angled forward wall to enhance the separation and collection of oil from the surface.

21. The apparatus of claim 20 and wherein the blade is hingedly connected along the upper edge of the forward wall such that the angle of the blade relative to horizontal can be adjusted for conditions.

22. The apparatus of claim 20 and further comprising an oil evacuation system for evacuating collected oil from the sump as additional oil is collected.

23. The apparatus of claim 22 and further comprising a water separation system for removing at least a portion of any water collected along with the collected oil.

24. The apparatus of claim 23 and wherein the water evacuation system is configured to expel the collected water in the path of the moving blade for recycling.

25. The system of claim 1 and wherein the platform is configured to be towed through the field of hazardous material.

26. The system of claim 1 and further comprising a rudder attached to the platform forward of a midpoint of the platform.

27. The system of claim 26 and wherein the rudder is located forward of the blade.

28. The method of claim 14 and wherein step (a) comprises moving the blade through the floating oil.

29. The method of claim 14 and wherein step (a) comprises locating the blade in a moving current of the floating oil.
